(19) United States
(12) Patent Application Publication
(10) Pub. No.: US 2025/0004247 A1
(43) Pub. Date: Jan. 2, 2025

(54) VIRTUAL REALITY OPTICAL LENS

(71) Applicant: AAC OPTICS (CHANGZHOU) CO., LTD., Changzhou City (CN)

(72) Inventor: Xiuting Shi, Changzhou (CN)

(21) Appl. No.: 18/395,784

(22) Filed: Dec. 26, 2023

(30) Foreign Application Priority Data
Jun. 28, 2023 (CN) 202310779098.4

(51) Int. Cl. G02B 13/00; G02B 5/30

(52) U.S. Cl. CPC G02B 13/0035; G02B 5/3083

(57) ABSTRACT

The present application discloses a virtual reality optical lens, including an image surface having a circular polarizer for emitting light; a third lens provided with a partially reflective element; a second lens; a first lens provided with a composite film, which includes a polarizing reflective film affixed to the front side surface of the first lens and a quarter-wave sheet affixed to the front side of the polarizing reflective film; an aperture, located at the rear side. A maximum visible diameter of the virtual reality optical lens is VD, a refractive index of the second lens is nd2, and a maximum semi-diameter of lenses of the virtual reality optical lens is SDmax. The following relationship expressions are satisfied: 1.80≤nd2; VD≥10.00 mm; SDmax≤23.00 mm. The virtual reality optical lens has excellent optical performance while satisfying the design requirements of small size and lightweight.

### TECHNICAL FIELD

The present application relates to the field of optical lenses, in particular to a virtual reality optical lens for VR devices.

### BACKGROUND

In recent years, with the rise of various smart devices, the demand for miniaturized virtual reality optical lenses has been increasing. Due to the reduction in pixel size of photosensitive devices and the current trend in electronic products towards functionality, lightness, and portability, miniaturized virtual reality optical lenses with excellent imaging quality have become mainstream in the current market. To achieve better imaging quality, a multi-lens structure is often employed. Furthermore, with the advancement of technology and the increasing diversification of user demands, especially in the rapidly growing applications of virtual reality, augmented reality, and mixed reality, there is an urgent need for virtual reality optical lenses that combine small size with excellent imaging methods, driven by the focus on user experience.

### SUMMARY

In response to the above problem, an object of the present application is to provide a virtual reality optical lens that has excellent optical performance while satisfying the design requirements of small size and lightweight.

In order to solve the above technical problems, an embodiment of the present application provides a virtual reality optical lens, comprising, in order from a front side to a rear side:
an image surface having a circular polarizer affixed to a rear side of the image surface for emitting light;
a third lens, a front side surface of which is provided with a partially reflective element;
a second lens;
a first lens, a front side surface of which is provided with a composite film; wherein the composite film comprises:
   a polarizing reflective film, affixed to the front side surface of the first lens; and
   a quarter-wave sheet, affixed to a front side of the polarizing reflective film;
an aperture arranged on the rear side of the virtual reality optical lens;
wherein a maximum visible diameter of the virtual reality optical lens is VD; a refractive index of the second lens is nd2; a maximum semi-diameter of lenses of the virtual reality optical lens is SDmax, and the following relationship expressions are satisfied:
1.80≤nd2;
VD≥10.00 mm;
SDmax≤23.00 mm.

In one embodiment, a rear side of the first lens is aspheric.

In one embodiment, a rear side and a front side of the second lens are spheric, and a rear side and a front side of the third lens are aspheric.

In one embodiment, a field of view of the virtual reality optical lens is FOV, and the following relationship expression is satisfied: 94.50°≤FOV.

In one embodiment, a total track length of the virtual reality optical lens is TTL, and the following relationship expression is satisfied: TTL≤19.427 mm.

In one embodiment, the partially reflective element is a semi-transparent semi-reflective film.

In one embodiment, a reflectivity and a transmittance of the semi-transparent semi-reflective film are both 50%.

In one embodiment, a reflectivity of the polarizing reflective film is ≥95%.

In one embodiment, an optical distortion of the virtual reality optical lens is ≤28.4%.

In one embodiment, a chromatic aberration of the virtual reality optical lens is ΔE, and |ΔE|≤57 μm is satisfied.

In one embodiment, a focal length of the virtual reality optical lens is f; a total track length of the virtual reality optical lens is TTL, and the following relationship expression is satisfied: TTL/f≤0.79.

In one embodiment, the image surface is a display with a size of 2.1 inches.

The beneficial effects of the present application lie in: the virtual reality optical lens according to the present application has excellent optical performance while possessing characteristics of small size and light weight. By providing a partially reflective element on the front side surface of the third lens and a composite film including a polarizing reflective film and a quarter-wave sheet in sequence on the first lens, a three-piece lens optical path folding structure is realized, and the semi-diameter of the lens is controlled to reduce the size of the optical system, thereby increasing the degree of freedom of design, obtaining the higher performance, and further improving the imaging quality. The maximum visible diameter is greater than or equal to 10.00 mm, allowing users to get the optimal display effect without tedious adjustments, and combining small size and high imaging performance. Besides, a single piece of high-refractive glass is used to reduce chromatic aberration through the combination of high-refractive materials and low-refractive materials.

### BRIEF DESCRIPTION OF THE DRAWINGS

In order to more clearly illustrate the technical solutions in the embodiments of the present application, the following will briefly introduce the accompanying drawings that need to be used in the description of the embodiments, and it will be obvious that the accompanying drawings in the following description are only some of the embodiments of the present application, and for the person of ordinary skill in the field, other accompanying drawings can be obtained based on these drawings without creative labor.

FIG. 1 is a structural schematic diagram of a virtual reality optical lens according to the first embodiment of the present application.

FIG. 2 is a spot diagram of the virtual reality optical lens shown in FIG. 1.

FIG. 3 is a schematic diagram showing the magnification chromatic aberration of the virtual reality optical lens shown in FIG. 1.

FIG. 4 is a schematic diagram showing the field curvature and distortion of the virtual reality optical lens shown in FIG. 1.

FIG. 5 is a schematic diagram of a contained film layer structure of the virtual reality optical lens shown in FIG. 1.

FIG. 6 is a structural schematic diagram of the virtual reality optical lens according to the second embodiment of the present application.

FIG. 7 is a spot diagram of the virtual reality optical lens shown in FIG. 6.

FIG. 8 is a schematic diagram showing the magnification chromatic aberration of the virtual reality optical lens shown in FIG. 6.

FIG. 9 is a schematic diagram showing the field curvature and distortion of the virtual reality optical lens shown in FIG. 6.

FIG. 10 is a schematic diagram of the contained film layer structure of the virtual reality optical lens shown in FIG. 6.

FIG. 11 is a structural schematic diagram of the virtual reality optical lens according to a comparative embodiment of the present application.

FIG. 12 is a spot diagram of the virtual reality optical lens shown in FIG. 11.

FIG. 13 is a schematic diagram showing the magnification chromatic aberration of the virtual reality optical lens shown in FIG. 11.

FIG. 14 is a schematic diagram showing the field curvature and distortion of the virtual reality optical lens shown in FIG. 11.

FIG. 15 is a schematic diagram of the contained film layer structure of the virtual reality optical lens shown in FIG. 11.

### DETAILED DESCRIPTION OF THE EMBODIMENTS

In order to make the objects, technical solutions, and advantages of the present application clearer, various embodiments of the present application will be described in detail below in connection with the accompanying drawings. However, those of ordinary skill in the art can understand that in the various embodiments of the present application, a number of technical details have been proposed in order to enable the reader to better understand the present application, and even without these technical details and various variations and modifications based on the following various embodiments, the technical solution claimed to be protected by the present application can be realized.

### First Embodiment

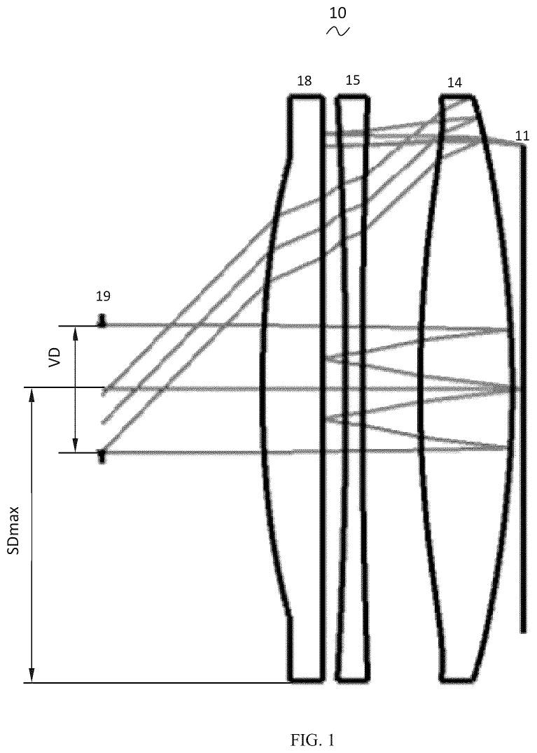

Referring to FIG. 1 and FIG. 5, the present application provides a virtual reality optical lens 10. Specifically, the virtual reality optical lens 10 includes, in order from a front side to a rear side: an image surface 11, a circular polarizer 12, a partially reflective element 13, a third lens 14, a second lens 15, a quarter-wave sheet 16, a polarizing reflective film 17, a first lens 18, and an aperture 19.

The image surface 11 is configured to emit light, which is provided with the circular polarizer 12 affixed to a rear side of the image surface 11. In this embodiment, the image surface 11 is a display with a size of 2.1 inches, and the light emitted from the display passes through the circular polarizer 12 to form a left-handed circularly polarized light LCP.

The front side surface 141 of the third lens 14 is provided with the partially reflective element 13, so that a part of the light is reflected and a part of the light is incident to the third lens 14, in which the light is left-handed circularly polarized light LCP.

The left circularly polarized light LCP incident to the third lens 14 is refracted by the third lens 14 and ejected to the second lens 15, and is refracted by the second lens 15 and ejected to the first lens 18.

The front side surface 181 of the first lens 18 is provided with a composite film, and the composite film includes the polarizing reflective film 17 and the quarter-wave sheet 16. The polarizing reflective film 17 is affixed to the front side surface 181 of the first lens 18, and the quarter-wave sheet 16 is affixed to the front side of the polarizing reflective film 17. The left-handed circularly polarized light LCP is converted into linearly polarized S light after passing through the quarter-wave sheet 16 for the first time, and is subsequently reflected back to the quarter-wave sheet 16 at the polarizing reflective film 17, at which time the reflected light is still linearly polarized S light. It is transformed into left-handed circularly polarized light LCP after passing through the quarter-wave sheet 16 for the second time and incident to the second lens 15 for the second time, and incident to the partially reflected element 13 after being refracted by second lens 15 and the third lens 14 in sequence, and partially reflected at the partially reflected element 13. The reflected light is transformed into the right-hand circularly polarized light RCP incident to the third lens 14 for the third time, and after being refracted by the third lens 14 and the second lens 15 in turn, it is incident to the quarter-wave sheet 16 and is transformed into linearly polarized P-light incident to the polarized reflective film 17. Since the polarizing reflective film 17 has the property of reflective linearly polarized S light and transmitting linearly polarized P light, the line-polarized P light is incident to the first lens 18, and enters the aperture 19 after being refracted by the first lens 18.

In this embodiment, a total track length (TTL) of the virtual reality optical lens 10 is greatly reduced by utilizing the 3-piece optical path folding structure, thereby reducing the size of the virtual reality optical lens 10.

In this embodiment, the first lens 18 is made of plastic material, the second lens 15 is made of glass material, and the third lens 14 is made of plastic material. In other embodiments, the respective lenses may also be made of other materials.

It is defined that the refractive index of the second lens 15 is nd2, and the following relationship expression is satisfied: 1.80≤nd2. The second lens 15 is selected to be made of H-ZF52 (glass) material, which effectively reduces chromatic aberration by using a piece of high-refractive glass through a combination of high-refractive material and low-refractive material while reducing cost.

The position of the aperture 19 simulates the position of the surface of the human eye, and the diameter of the aperture 19 is 10.00 mm. It is defined that the maximum visible diameter of the virtual reality optical lens 10 is VD, and the following expression is satisfied: 10*10 mm≤VD. That is, the human eye can see a clear image when it is moved within the range of a diameter of at least 10 mm, so that the user does not need to cumbersomely adjust the optimal position to see the optimal display effect, increasing the FOV, so that the FOV can reach more than 90°.

It is defined that the maximum semi-diameter of the lens of the virtual reality optical lens 10 is SDmax, and the following relationship expression is satisfied: SDmax≤23.00 mm, which is conducive to reducing the size of the virtual reality optical lens. The degree of freedom of design is increased through the folding structure of the optical path of the three lenses, thereby obtaining higher optical performance, and improving the quality of imaging.

In this embodiment, the rear side surface 183 of the first lens 18 is aspheric, and the provision of at least one aspheric surface is conducive to reducing the total track length. In other embodiments, free-form surfaces may also be used.

In this embodiment, the rear side surface 153 and the front side surface 151 of the second lens 15 are spheric, and the rear side surface 143 and the front side surface 141 of the third lens 14 are aspheric. The application of aspheric surfaces is favorable for correcting the aberration of the optical system. In other embodiments, free-form surfaces may also be adopted.

In this embodiment, the front side surface 181 of the first lens 18 is planar, and the rear side surface 183 of the first lens 18 is convex. The front side surface 151 of the second lens 15 is concave, and the rear side surface 153 of the second lens 15 is concave. The front side surface 141 of the third lens 14 is convex, and the rear side surface 143 of the third lens 14 is convex.

In this embodiment, a field of view of the virtual reality optical lens 10 is defined as FOV and the following relationship expression is satisfied: 94.50°≤FOV, thereby realizing a wide angle so that the user can see the optimal display effect at the best position.

In this embodiment, it is defined that a total track length of the virtual reality optical lens 10 is TTL, and the following relationship expression is satisfied: TTL≤19.427 mm, which is conducive to realizing ultra-thinness.

In this embodiment, the partially reflective element 13 is a semi-transparent semi-reflective film, and a reflectivity and transmittance of the semi-transparent semi-reflective film are both 50%, which makes the optical performance of the virtual reality optical lens 10 better. In other embodiments, the reflection-transmission ratio of the partially reflective element 13 may be adjusted according to specific design requirements, or it may be 55:45, 60:40, and so on.

In this embodiment, a reflectivity of the polarizing reflective film 17 is ≥95%, and a higher reflectivity improves the light efficacy of the virtual reality optical lens 10 and increases the display brightness.

In this embodiment, an optical distortion of the virtual reality optical lens 10 is ≤28.4%, which makes the optical performance of the virtual reality optical lens 10 better with less distortion, thereby providing a more realistic VR environment to the user.

In this embodiment, it is defined that a chromatic aberration of the virtual reality optical lens 10 is ΔE, and |ΔE|≤57 μm is satisfied.

In this embodiment, it is defined that a focal length of the virtual reality optical lens is f, and the total track length of the virtual reality optical lens is TTL. and the following relationship expression is satisfied: TTL/f≤0.79, which is conducive to realizing ultra-thinness.

In this embodiment, the rear side surface 183 of the first lens 18, the front side surface 151 of the second lens 15, the rear side surface 153 of the second lens 15, and the rear side surface 143 of the third lens 14 are provided with a transmittance-enhancing film to improve the light efficacy of the virtual reality optical lens 10 and increase the brightness.

In this embodiment, an aperture value FNO of the virtual reality optical lens 10 is less than or equal to 2.47, which makes the virtual reality optical lens 10 miniaturized and has excellent imaging performance.

The virtual reality optical lens 10 of the present application will be described below with examples. The symbols recorded in each example are shown below. The units of focal length, on-axis distance, central radius of curvature, on-axis thickness, position of inflection point position, and position of stationary point position are mm.

TTL: total track length, which refers to an on-axis distance from the image surface 11 to the rear side surface 183 of the first lens 18, is in mm;

Aperture Value FNO: a ratio of the effective focal length of the virtual reality optical lens to the Entrance Pupil Diameter.

In an embodiment, the lens may also be provided with an inflection point and/or a stationary point on the front and/or rear side of the lens to satisfy the need for high-quality imaging, and specific implementable embodiments are described below.

Tables 1 and 2 show the design data of the virtual reality optical lens 10 according to the first embodiment of the present application.

TABLE 1

| | R | d | | nd | | νd | |
|---|---|---|---|---|---|---|---|
| IMAGE | ∞ | ∞ | | | | | |
| Aperture | ∞ | d0= | 12.000 | | | | |
| R1 | 99.313 | d1= | 4.530 | nd1 | 1.5444 | ν1 | 56.28 |
| R2 | ∞ | d2= | 1.679 | | | | |
| R3 | −429.909 | d3= | 1.239 | nd2 | 1.8467 | ν2 | 23.79 |
| R4 | 644.778 | d4= | 4.309 | | | | |
| R5 | 119.840 | d5= | 6.885 | nd3 | 1.5444 | ν3 | 56.28 |
| R6 | −89.247 | d6= | −6.885 | | | | |
| R5 | 119.840 | d7= | −4.309 | | | | |
| R4 | 644.778 | d8= | −1.239 | nd2 | 1.8467 | ν2 | 23.79 |
| R3 | −429.909 | d9= | −1.679 | | | | |
| R2 | ∞ | d2= | 1.679 | | | | |
| R3 | −429.909 | d3= | 1.239 | nd2 | 1.8467 | ν2 | 23.79 |
| R4 | 644.778 | d4= | 4.309 | | | | |
| R5 | 119.840 | d5= | 6.885 | nd3 | 1.5444 | ν3 | 56.28 |
| R6 | −89.247 | d10= | 0.785 | | | | |
| Image | ∞ | | | | | | |
| Surface | | | | | | | |

The meanings of the symbols in the table are as follows:
R: central radius of curvature of the optical surface;
R1: central radius of curvature of the rear side of the first lens 18;
R2: central radius of curvature of the front side of the first lens 18;
R3: central radius of curvature of the rear side of the second lens 15;
R4: central radius of curvature of the front side of the second lens 15;
R5: central radius of curvature of the rear side of the third lens 14;
R6: central radius of curvature of the front side of the third lens 14;
d: on-axis thickness of the lens, the on-axis distance between the lenses (to facilitate the understanding of the optical path, the propagation of the light from the rear side to the front side is set as a positive value, and the propagation of the light from the front side to the rear side is set as a negative value);
d0: on-axis distance from the aperture 19 to the rear side surface 183 of the first lens 18;
d1: on-axis thickness of the first lens 18;
d2: on-axis distance from the front side surface 181 of the first lens 18 to the rear side surface 153 of the second lens 15;
d3: on-axis thickness of the second lens 15;
d4: on-axis distance from the front side surface 151 of the second lens 15 to the rear side surface 143 of the third lens 14;
d5: on-axis thickness of the third lens 14;
d6: negative value of the on-axis thickness of the third lens 14;
d7: negative value of the on-axis distance from the front side surface 151 of the second lens 15 to the rear side surface 143 of the third lens 14;
d8: negative value of the on-axis thickness of the second lens 15;
d9: negative value of the on-axis distance from the front side surface 181 of the first lens 18 to the rear side surface 153 of the second lens 15;
d10: on-axis distance from the front side surface 141 of the third lens 14 to the image surface 11;
nd: refractive index of the line d (the line d is green light having a wavelength of 546 nm);
nd1: refractive index of the line d of the first lens 18;
nd2: the refractive index of the line d of the second lens 15;
nd3: refractive index of the line d of the third lens 14;
vd: Abbe number;
v1: the Abbe number of the first lens 18;
v2: Abbe number of the second lens 15;
v3: Abbe number of the third lens 14;

Table 2 illustrates the aspheric surface data of each lens in the virtual reality optical lens 10 according to the first embodiment of the present application.

TABLE 2

Cone

| | |
|---|---|
| Coefficient | Aspheric Coefficient |

| | k | A4 | A6 | A8 | A10 | A12 |
|---|---|---|---|---|---|---|
| R1 | 1.49499E+00 | 4.14040E−06 | 1.80213E−07 | −2.17254E−09 | 1.40524E−11 | −8.40599E−14 |
| R5 | 1.27417E+00 | 5.53650E−06 | −2.92645E−08 | −5.56779E−11 | 2.49382E−13 | −1.56516E−15 |
| R6 | 1.63849E+00 | 1.84901E−05 | −7.14192E−08 | 1.53329E−09 | −2.03428E−11 | 1.43138E−13 |

| | Cone | | | | | |
|---|---|---|---|---|---|---|
| | Coefficient | Aspheric Coefficient | | | | |
| | k | A14 | A16 | A18 | A20 | A22 |
| R1 | 1.49499E+00 | 3.84922E−16 | −8.68049E−19 | 9.80360E−22 | −4.29308E−24 | 6.91809E−27 |
| R5 | 1.27417E+00 | 8.76172E−18 | −2.77984E−20 | 3.22388E−23 | −2.38759E−26 | −8.43415E−30 |
| R6 | 1.63849E+00 | −5.87123E−16 | 1.40114E−18 | −2.00990E−21 | 4.28503E−25 | −1.93327E−27 |

| | Cone | | | | |
|---|---|---|---|---|---|
| | Coefficient | Aspheric Coefficient | | | |
| | k | A24 | A26 | A28 | A30 |
| R1 | 1.49499E+00 | −5.82135E−30 | 3.17640E−31 | −1.24953E−33 | 1.28100E−36 |
| R5 | 1.27417E+00 | 3.53767E−32 | 2.26787E−34 | 4.67890E−37 | −1.29528E−39 |
| R6 | 1.63849E+00 | 2.17329E−29 | 3.17330E−32 | 6.91036E−36 | −4.52262E−37 |

For convenience, the aspheric surfaces of the individual lens surfaces use the aspheric surfaces shown in Equation (1) below. However, the present application is not limited to the polynomial form of the aspheric surfaces expressed in Equation (1).

$$z = ( {cr}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} + A 22 {r}^{22} + A 24 {r}^{24} + A 26 {r}^{26} + A 28 {r}^{28} + A 30 {r}^{30} \qquad ( 1 )$$

k is the conic coefficient, A4, A6, A8, A10, A12, A14, A16, A18, A20, A22, A24, A26, A28, A30 is the aspheric coefficient, c is the curvature at the center of the optical surface, r is the perpendicular distance between the point on the aspheric curve and the optical axis, and z is the depth of the aspheric surface (the perpendicular distance between the point on the aspheric surface at a distance of r from the optical axis and the tangent surface tangent to the apex on the aspheric optical axis).

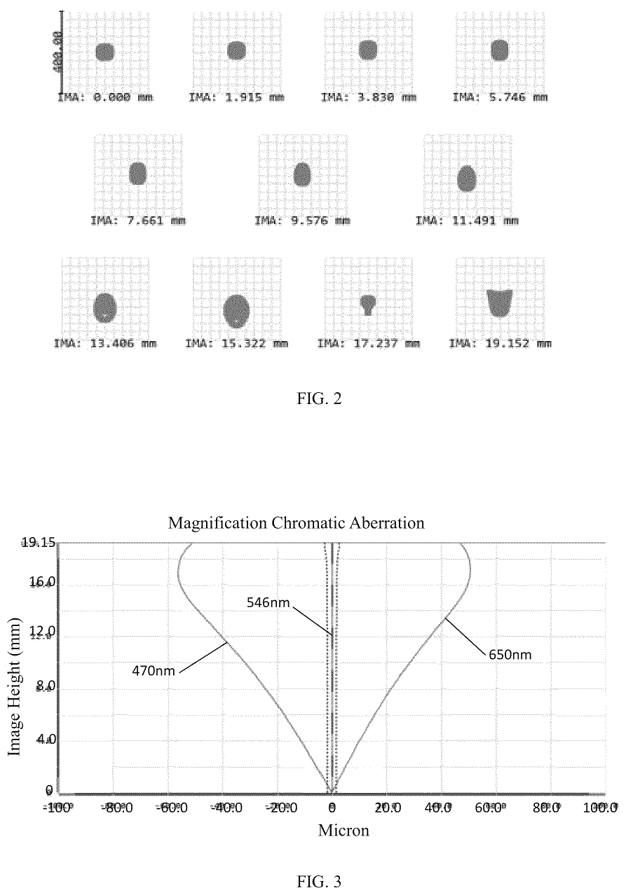

FIG. 2 illustrates a spot diagram of the virtual reality optical lens 10, and it can be seen that the virtual reality optical lens 10 has small dispersion spot size and an excellent imaging effect.

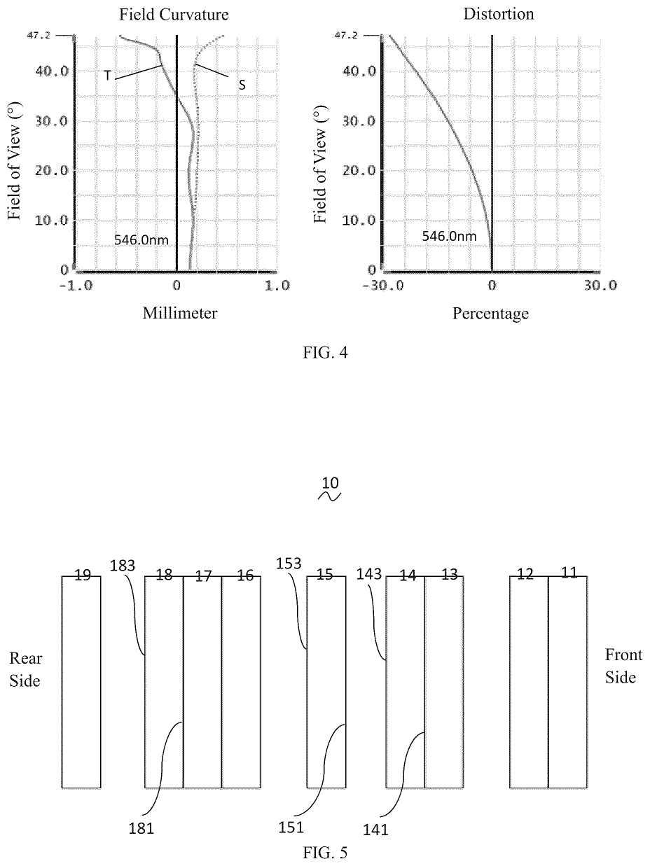

FIG. 3 is a schematic diagram showing the magnification chromatic aberration of light with wavelengths of 470 nm, 546 nm, and 650 nm after passing through the virtual reality optical lens 10 according to the first embodiment. FIG. 4 is a schematic diagram showing the field curvature and distortion of light with a wavelength of 546 nm after passing through the virtual reality optical lens 10 according to the first embodiment. The field curvature S of FIG. 4 is a field curvature in the arc-sagittal direction and T is a field curvature in the meridional direction.

In this embodiment, the virtual reality optical lens 10 has an Entrance Pupil Diameter (ENPD) of 10.000 mm, a full field-of-view image height (IH) of 19.152 mm, and a field of view (FOV) of 94.50° in the diagonal direction. The virtual reality optical lens 10 satisfies the design requirements of a small volume and a maximum visible diameter greater than or equal to 10.00 mm. Through the optical path folding structure of three lenses, it increases the degree of freedom of design and can obtain higher performance, thereby improving the imaging quality. Due to its on-axis and off-axis chromatic aberration is sufficiently compensated for, the chromatic aberration is reduced, so the virtual reality optical lens 10 possesses excellent optical characteristics.

As shown in Table 7, the first embodiment satisfies each of the relationship expressions.

### Second Embodiment

The second embodiment is basically the same as the first embodiment, the meaning of the symbols is the same as that of the first embodiment, and only the differences are listed below.

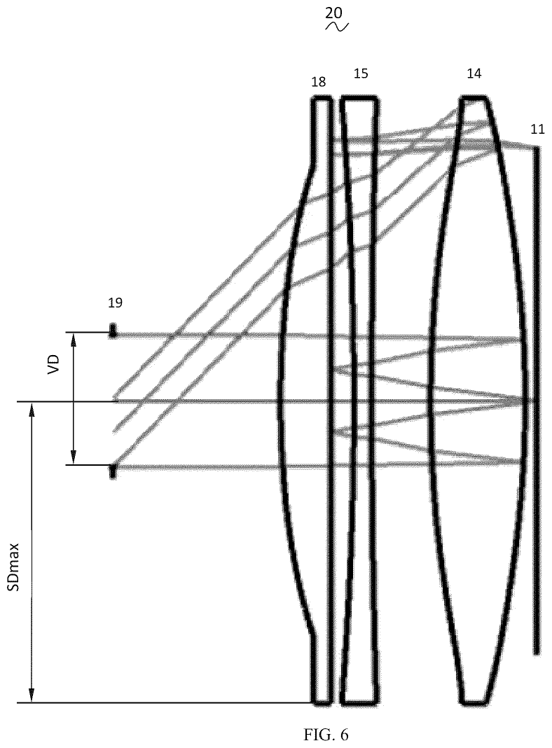

FIG. 6 shows a virtual reality optical lens 20 according to the second embodiment of the present application.

Tables 3 and 4 show design data of the virtual reality optical lens 20 according to the second embodiment of the present application.

TABLE 3

| | R | d | | nd | | νd | |
|---|---|---|---|---|---|---|---|
| IMAGE | ∞ | ∞ | | | | | |
| Aperture | ∞ | d0= | 12.000 | | | | |
| R1 | 84.489 | d1= | 3.593 | nd1 | 1.5444 | ν1 | 56.28 |
| R2 | ∞ | d2= | 1.680 | | | | |
| R3 | −295.353 | d3= | 1.263 | nd2 | 2.0007 | ν2 | 25.44 |
| R4 | 740.109 | d4= | 4.237 | | | | |
| R5 | 106.848 | d5= | 6.802 | nd3 | 1.5444 | ν3 | 56.28 |
| R6 | −86.924 | d6= | −6.802 | | | | |
| R5 | 106.848 | d7= | −4.237 | | | | |
| R4 | 740.109 | d8= | −1.263 | nd2 | 2.0007 | ν2 | 25.44 |
| R3 | −295.353 | d9= | −1.680 | | | | |
| R2 | ∞ | d2= | 1.680 | | | | |
| R3 | −295.353 | d3= | 1.263 | nd2 | 2.0007 | ν2 | 25.44 |
| R4 | 740.109 | d4= | 4.237 | | | | |
| R5 | 106.848 | d5= | 6.802 | nd3 | 1.5444 | ν3 | 56.28 |
| R6 | −86.924 | d10= | 0.789 | | | | |
| Image | ∞ | | | | | | |
| Surface | | | | | | | |

Table 4 illustrates aspheric surface data for each lens in the virtual reality optical lens 20 according to the second embodiment of the present application.

TABLE 4

| | Cone | | | | | |
|---|---|---|---|---|---|---|
| | Coefficient | Aspheric Coefficient | | | | |
| | k | A4 | A6 | A8 | A10 | A12 |
| R1 | 1.21627E+01 | 1.36405E−05 | 1.18199E−07 | −2.55257E−09 | 1.29757E−11 | −8.57057E−14 |
| R5 | 1.21147E+01 | 5.95168E−06 | −3.01839E−08 | −5.47835E−11 | 2.55851E−13 | −1.53906E−15 |
| R6 | 4.96868E+00 | 1.98399E−05 | −6.58521E−08 | 1.54397E−09 | −2.02982E−11 | 1.43368E−13 |
| | Cone | | | | | |
| | Coefficient | Aspheric Coefficient | | | | |
| | k | A14 | A16 | A18 | A20 | A22 |
| R1 | 1.21627E+01 | 3.90543E−16 | −7.16367E−19 | 2.92662E−21 | 3.99893E−23 | 8.51722E−26 |
| R5 | 1.21147E+01 | 8.85723E−18 | −2.74963E−20 | 3.30196E−23 | −2.23752E−26 | −6.82671E−30 |
| R6 | 4.96868E+00 | −5.86071E−16 | 1.40525E−18 | −1.99628E−21 | 4.72196E−25 | −1.81355E−27 |

| | Cone | | | | |
|---|---|---|---|---|---|
| | Coefficient | Aspheric Coefficient | | | |
| | k | A24 | A26 | A28 | A30 |
| R1 | 1.21627E+01 | −4.35908E−27 | 2.52575E−30 | 2.43347E−32 | 1.71425E−34 |
| R5 | 1.21147E+01 | 3.39578E−32 | 2.13395E−34 | 4.19938E−37 | −1.43285E−39 |
| R6 | 4.96868E+00 | 2.20158E−29 | 3.21951E−32 | 2.02951E−36 | −5.83112E−37 |

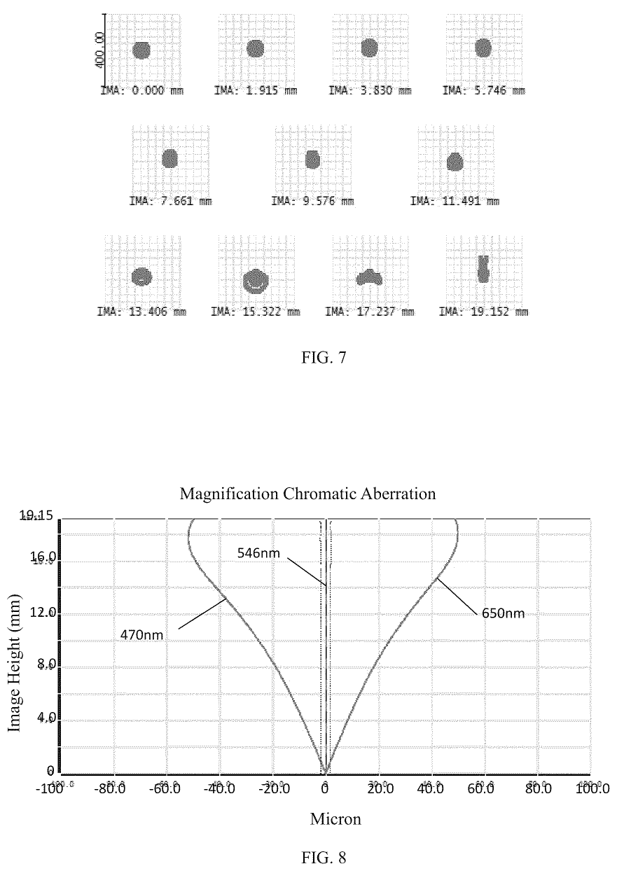

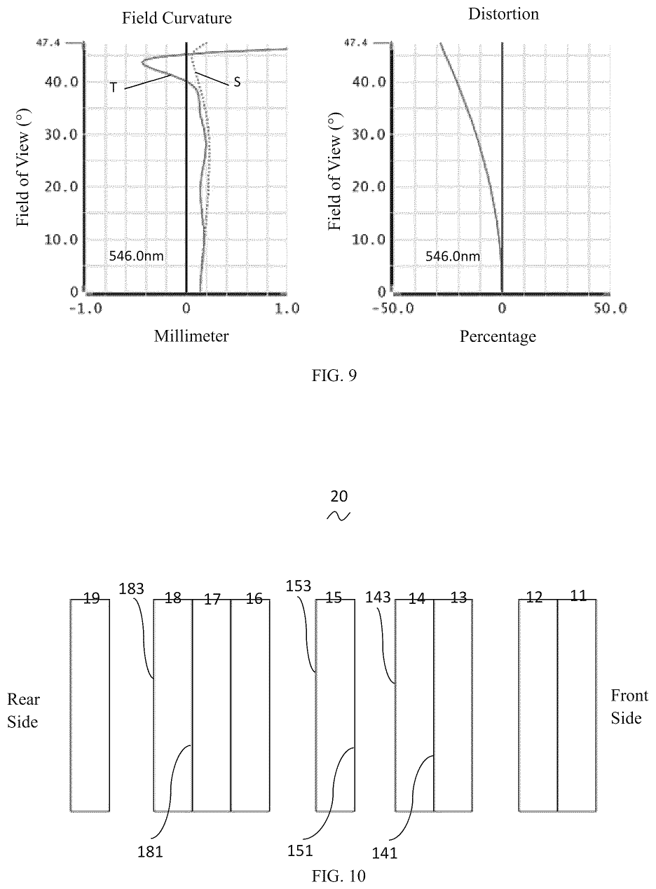

FIG. 7 illustrates a spot diagram of the virtual reality optical lens 20, and it can be seen in FIG. 7 that the virtual reality optical lens 20 has a small dispersion spot size and an excellent imaging effect.

FIG. 8 is a schematic diagram showing the magnification chromatic aberration of light with wavelengths of 470 nm, 546 nm, and 650 nm, respectively, after passing through the virtual reality optical lens 20 according to the second embodiment. FIG. 9 is a schematic diagram showing the field curvature and distortion of light with a wavelength of 546 nm after passing through the virtual reality optical lens 20 according to the second embodiment. The field curvature S of FIG. 9 is the field curvature in the arc-sagittal direction and T is the field curvature in the meridional direction.

As shown in Table 7, the second embodiment satisfies each of the relationship expressions.

In this embodiment, the virtual reality optical lens 20 has an Entrance Pupil Diameter (ENPD) of 10.000 mm, a full field-of-view image height (IH) of 19.152 mm, and a field of view (FOV) of 94.87° in the diagonal direction. The virtual reality optical lens 10 satisfies the design requirements of a small volume and a maximum visible diameter greater than or equal to 10.00 mm. Through the optical path folding structure of three lenses, it increases the degree of freedom of design and can obtain higher performance, thereby improving the imaging quality. Due to its on-axis and off-axis chromatic aberration is sufficiently compensated for, the chromatic aberration is reduced, so the virtual reality optical lens 10 possesses excellent optical characteristics.

### Comparative Embodiment

The comparative embodiment is essentially the same as the first embodiment, the meaning of the symbols is the same as that of the first embodiment, and only the differences are listed below.

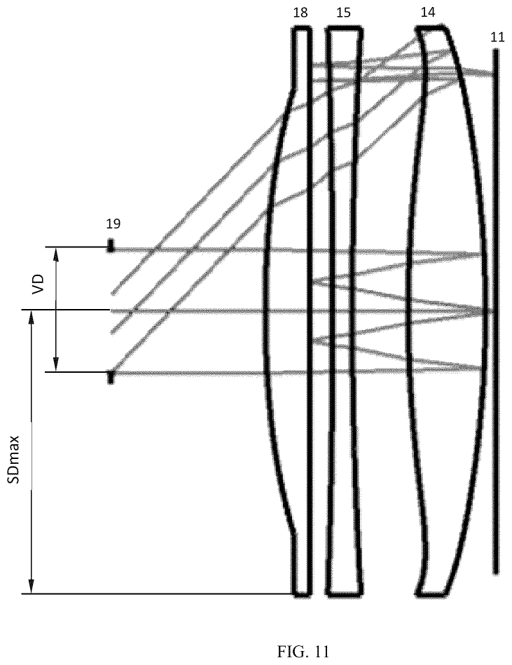

FIG. 11 shows a virtual reality optical lens 30 of the comparative embodiment of the present application.

Tables 5 and 6 show design data of the virtual reality optical lens 30 of the comparative embodiment of the present application.

TABLE 5

| | R | d | | nd | | νd | |
|---|---|---|---|---|---|---|---|
| IMAGE | ∞ | ∞ | | | | | |
| Aperture | ∞ | d0= | 12.000 | | | | |
| R1 | 93.259 | d1= | 3.498 | nd1 | 1.5444 | ν1 | 56.28 |
| R2 | ∞ | d2= | 1.760 | | | | |
| R3 | −703.599 | d3= | 1.505 | nd2 | 1.7130 | ν2 | 53.87 |
| R4 | 391.825 | d4= | 4.371 | | | | |
| R5 | 114.406 | d5= | 6.022 | nd3 | 1.5444 | ν3 | 56.28 |
| R6 | −91.542 | d6= | −6.022 | | | | |
| R5 | 114.406 | d7= | −4.371 | | | | |
| R4 | 391.825 | d8= | −1.505 | nd2 | 1.7030 | ν2 | 53.87 |
| R3 | −703.599 | d9= | −1.760 | | | | |
| R2 | ∞ | d2= | 1.760 | | | | |
| R3 | −703.599 | d3= | 1.505 | nd2 | 1.7130 | ν2 | 53.87 |
| R4 | 391.825 | d4= | 4.371 | | | | |
| R5 | 114.406 | d5= | 6.022 | nd3 | 1.5444 | ν3 | 56.28 |
| R6 | −91.542 | d10= | 0.773 | | | | |
| Image | ∞ | | | | | | |
| Surface | | | | | | | |

Table 6 illustrates aspheric data for each lens in the virtual reality optic 30 of the comparative embodiment of the present application.

TABLE 6

| | |
|---|---|
| Cone | |
| Coefficient | Aspheric Coefficient |

| | k | A4 | A6 | A8 | A10 | A12 |
|---|---|---|---|---|---|---|
| R1 | 1.38923E+01 | 1.00321E−05 | 1.51120E−07 | −2.45981E−09 | 1.34109E−11 | −7.85094E−14 |
| R5 | 7.17985E+00 | 4.68800E−06 | −3.64676E−08 | −7.86488E−11 | 1.95736E−13 | −1.65104E−15 |
| R6 | 6.20220E+00 | 1.70084E−05 | −8.32368E−08 | 1.49475E−09 | −2.04508E−11 | 1.42822E−13 |

| | Cone | | | | | |
|---|---|---|---|---|---|---|
| | Coefficient | Aspheric Coefficient | | | | |
| | k | A14 | A16 | A18 | A20 | A22 |
| R1 | 1.38923E+01 | 4.53672E−16 | −5.79250E−19 | 1.66531E−22 | −2.53256E−23 | −1.17821E−25 |
| R5 | 7.17985E+00 | 8.72159E−18 | −2.75240E−20 | 3.32341E−23 | −2.21966E−26 | −6.90290E−30 |
| R6 | 6.20220E+00 | −5.87976E−16 | 1.39982E−18 | −1.99719E−21 | 5.72992E−25 | −1.03240E−27 |

| | |
|---|---|
| Cone | |
| Coefficient | Aspheric Coefficient |

| | k | A24 | A26 | A28 | A30 |
|---|---|---|---|---|---|
| R1 | 1.38923E+01 | 2.03620E−28 | 1.40687E−29 | −3.61787E−32 | −1.25574E−34 |
| R5 | 7.17985E+00 | 3.56863E−32 | 2.24937E−34 | 4.62688E−37 | −1.31642E−39 |
| R6 | 6.20220E+00 | 2.54796E−29 | 4.04868E−32 | −5.97541E−36 | −7.07358E−37 |

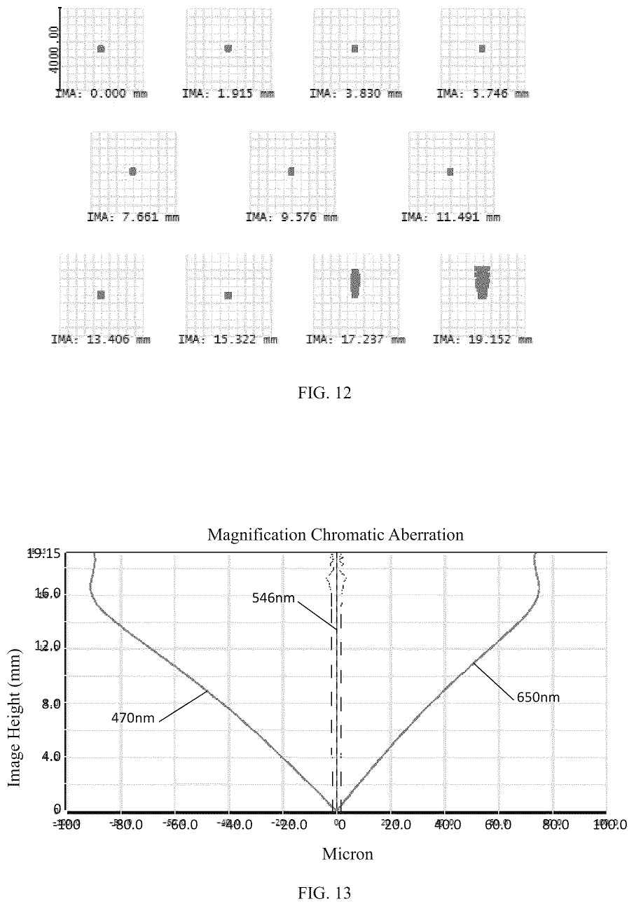

FIG. 12 illustrates a spot diagram of the virtual reality optical lens 30.

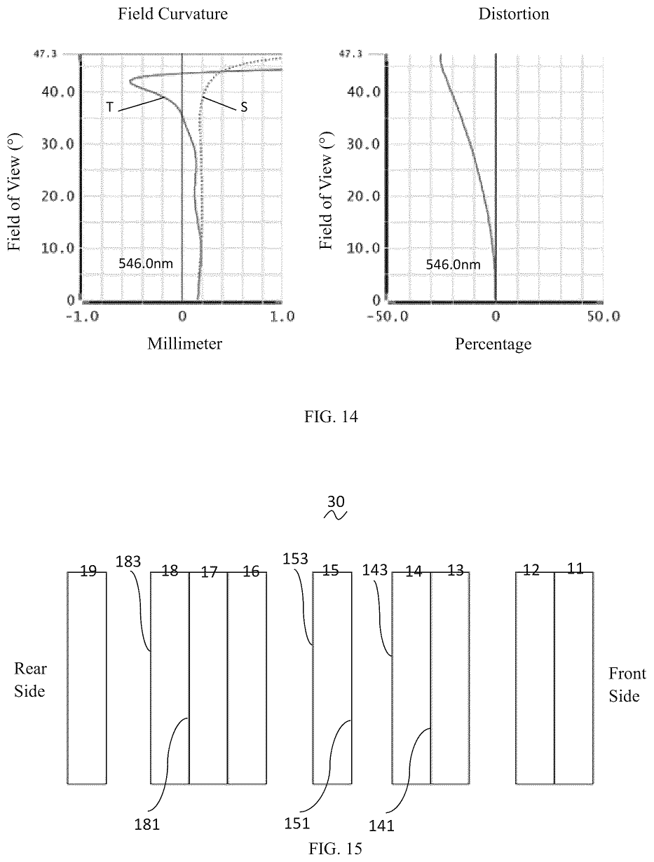

FIG. 13 is a schematic diagram showing the axial aberration and magnification chromatic aberration of light with wavelengths of 470 nm, 546 nm, and 650 nm, respectively, after passing through the virtual reality optical lens 30 of the comparative embodiment. FIG. 12 is a schematic diagram showing the field curvature and distortion of light of wavelength 546 nm after passing through the virtual reality optical lens 30 of the comparative embodiment. The field curvature S of FIG. 14 is the field curvature in the arc-sagittal direction, and T is the field curvature in the meridional direction.

Table 7 below lists the values corresponding to each of the relationship expressions in the comparative embodiments in accordance with the above relationship expressions. It is clear that the virtual reality optical lens 30 according to the comparative embodiment does not satisfy the relationship expression 1.80≤nd2.

In the comparative embodiment, the virtual reality optical lens 30 has an Entrance Pupil Diameter (ENPD) of 10.000 mm, a full field-of-view image height (IH) of 19.152 mm, and a field of view (FOV) of 94.60° in the diagonal direction. The second lens 15 of the virtual reality optical lens 30 uses a material with a refractive index of 1.713, which does not satisfy the relationship expression 1.80≤nd2. The chromatic aberration increases significantly and is difficult to control, and its on-axis and off-axis chromatic aberration is not sufficiently compensated for, and thus the virtual reality optical lens 30 does not have excellent optical characteristics.

TABLE 7

| Parameters and | | | |
|---|---|---|---|
| relationship | First | Second | Comparative |
| expressions | Embodiment | Embodiment | Embodiment |
| VD | 10.00 | 10.00 | 10.00 |
| f | 24.698 | 24.594 | 24.276 |
| SDmax | 23.00 | 23.00 | 23.00 |
| nd2 | 1.8467 | 2.0007 | 1.7130 |
| FNO | 2.47 | 2.45 | 2.42 |
| TTL | 19.427 | 18.364 | 17.928 |
| IH | 19.152 | 19.152 | 19.152 |
| FOV | 94.50° | 94.87° | 94.60° |

It can be understood by those of ordinary skill in the art that each of the above embodiments is a specific embodiment for realizing the present application, and that various changes can be made thereto in form and detail in practical application without departing from the spirit and scope of the present application.

What is claimed is:

1. A virtual reality optical lens, comprising, in order from a front side to a rear side:
an image surface having a circular polarizer affixed to a rear side of the image surface for emitting light;
a third lens, a front side surface of which is provided with a partially reflective element;
a second lens;
a first lens, a front side surface of which is provided with a composite film; wherein the composite film comprises:
a polarizing reflective film, affixed to the front side surface of the first lens; and
a quarter-wave sheet, affixed to a front side of the polarizing reflective film;
an aperture arranged on the rear side of the virtual reality optical lens;
wherein a maximum visible diameter of the virtual reality optical lens is VD; a refractive index of the second lens is nd2; a maximum semi-diameter of lenses of the virtual reality optical lens is SDmax, and the following relationship expressions are satisfied:
1.80≤nd2;
VD≥10.00 mm;
SDmax≤23.00 mm.

2. The virtual reality optical lens of claim 1, wherein a rear side of the first lens is aspheric.

3. The virtual reality optical lens of claim 1, wherein a rear side and a front side of the second lens are spheric, and a rear side and a front side of the third lens are aspheric.

4. The virtual reality optical lens of claim 1, wherein a field of view of the virtual reality optical lens is FOV, and the following relationship expression is satisfied:
94.50°≤FOV.

5. The virtual reality optical lens of claim 1, wherein a total track length of the virtual reality optical lens is TTL, and the following relationship expression is satisfied:
TTL≤19.427 mm.

6. The virtual reality optical lens of claim 1, wherein the partially reflective element is a semi-transparent and semi-reflective film.

7. The virtual reality optical lens of claim 6, wherein a reflectivity and a transmittance of the semi-transparent semi-reflective film are both 50%.

8. The virtual reality optical lens of claim 1, wherein a reflectivity of the polarizing reflective film is ≥95%.

9. The virtual reality optical lens of claim 1, wherein an optical distortion of the virtual reality optical lens is ≤28.4%.

10. The virtual reality optical lens of claim 1, wherein a chromatic aberration of the virtual reality optical lens is ΔE, and |ΔE|≤57 μm is satisfied.

11. The virtual reality optical lens of claim 1, wherein a focal length of the virtual reality optical lens is f; a total track length of the virtual reality optical lens is TTL, and the following relationship expression is satisfied:
TTL/f≤0.79.

12. The virtual reality optical lens of claim 1, wherein the image surface is a display with a size of 2.1 inches.
